(19) United States
(12) Patent Application Publication
(10) Pub. No.: US 2024/0093038 A1
(43) Pub. Date: Mar. 21, 2024

(54) ANTI-MICROBIAL AND/OR NON-STICK COATINGS FOR DRYER COMPONENTS AND OTHER EQUIPMENT

(71) Applicants: Viktor Burovsky, Brooklyn, NY (US); Marat Gekelman, Brooklyn, NY (US)

(72) Inventors: Viktor Burovsky, Brooklyn, NY (US); Marat Gekelman, Brooklyn, NY (US)

(21) Appl. No.: 18/191,530

(22) Filed: Mar. 28, 2023

Related U.S. Application Data
(60) Provisional application No. 63/376,485, filed on Sep. 21, 2022.
(60) Provisional application No. 63/376,491, filed on Sep. 21, 2022.

(51) Int. Cl. C09D 5/14; C09D 7/61

(52) U.S. Cl. CPC C09D 5/14; C09D 7/61

(57) ABSTRACT

A method for preventing buildup of synthetic fibers and lint and the human-harming microbes that grow thereon along the inside of a dryer. The method embodies coating the dryer components and other associated equipment with a non-stick surface to prevent buildup of synthetic fibers and lint. The method further includes coating silver ionic producing material along the inside of the dryer components and other operatively associated equipment like vents, fans, and ducts.

### CROSS-REFERENCE TO RELATED APPLICATION

This application claims the benefit of priority of U.S. provisional applications No. 63/376,485, filed Sep. 21, 2022, and No. 63/376,491, filed Sep. 21, 2022, the contents of both are herein incorporated by reference.

### BACKGROUND OF THE INVENTION

The present invention relates to dryers, heating, ventilation, and air conditioning systems and their subcomponents, more particularly, to an anti-microbial coating and/or nonstick coating for dryers, heating, ventilation, and/or air conditioning systems and their subcomponents, including but not limited to vents, fans, and other components.

Dryers are used in almost every household, public laundromats, and on-premises laundry (OPL) daily. Clothes put in the dryers are subject to moist hot air and tumbling, often leading to fibers and lint falling off the clothes and accumulating on the dryer components. Then these synthetic fibers and lint often melt and adhere on many of the dryer components. This presents a breeding ground for bacteria and microbes, which are often unhealthy or toxic to humans who contact the bacteria and microbes.

Furthermore, the melted synthetic fibers and lint also presents a fire hazard. Presently, dryers are not adapted for preventing this hazard.

Moreover, the aesthetic of the drum is diminished by the adherence of accumulated lint, fibers, lip balms, chewing gum, crayons, wash scent booster beads and other materials that makes drum of the dryer looks dirty.

Currently, there are no methods that embodying using nonstick or/and anti-microbial coatings to prevent this growth. The present lack of a satisfactory solution is problematic because clothes are routinely placed in the dryer then worn with skin-to-clothes contact. Presently, there is also no satisfactory methods or solutions for preventing the fire hazard and aesthetically displeasing buildup described above.

As can be seen, there is a need for a coating-related methods that prevent microbial growth from accumulating in a dryer as well as prevent lint and synthetic fibers from adhering to components of dryers, heating, ventilation, and/or air conditioning systems and their subcomponents.

### SUMMARY OF THE INVENTION

In one aspect of the present invention, a method for hindering bacterial replication in a dryer, the method includes forming silver ions along a surface of a dryer components, wherein the formation of silver ion is embodied in silver oxide along said surface, wherein the formation of silver ion is embodied in an anti-microbial coating along said surface, wherein the anti-microbial coating embodies matrix material nanoparticles containing metals that produce the silver ions, wherein the matrix material nanoparticles is glass, wherein the matrix material nanoparticles is an inorganic material, and/or wherein the anti-microbial coating.

In another aspect of the present invention, a method for preventing buildup of synthetic fibers and lint includes coating the dryer components with a non-stick coating. Also, the aesthetic of the drum is diminished by the adherence of accumulated lint, fibers, lip balms, chewing gum, crayons, wash scent booster beads and other materials that makes drum of the dryer looks dirty

In yet another aspect of the present invention, a method includes coating the inside of a dryer with non-stick coating and the silver ionic producing material.

These and other features, aspects and advantages of the present invention will become better understood with reference to the following drawings, description, and claims.

### BRIEF DESCRIPTION OF THE DRAWINGS

FIG. 1 is an elevation view of an exemplary embodiment of the present invention of an inside of a dryer illustrating, through stippling, the buildup of melted lint and fiber 10 in a dryer drum 20.

FIG. 2 is an elevation view of an exemplary embodiment of the present invention of the inside of the dryer drum illustrating, through stippling, the buildup of lint and fiber 10 in a dryer drum 20.

FIG. 3 is a perspective view of an exemplary embodiment of the present invention of an exterior of a dryer drum illustrating the buildup of melted lint and fiber 10 along the exterior of the dryer drum 20.

FIG. 4 is an elevation view of an exemplary embodiment of the present invention of an outside of the dryer drum 10 illustrating, through stippling, the buildup of melted lint and fiber.

FIG. 5 is an elevation view of an exemplary embodiment of the present invention of the inside of the dryer drum 10 illustrating, through stippling, the buildup of melted lint and fiber.

FIG. 6 is an elevation view of an exemplary embodiment of the present invention of the inside of the dryer drum illustrating, through stippling, the buildup of melted lint and fiber.

FIG. 7 is an elevation view of an exemplary embodiment of the present invention, illustrating, through stippling, the buildup of melted lint and fiber 10 in a duct 30.

FIG. 8 is an elevation view of an exemplary embodiment of the present invention, illustrating, through stippling, the buildup of melted lint and fiber 10 in a vent piping 40.

FIG. 9 is a perspective view of an exemplary embodiment of the present invention, illustrating, through stippling, the buildup of melted lint and fiber 10 in a fan 50.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a non-stick and/or anti-microbial coating for dryer components or other heating, ventilation and/or air condition systems and their subcomponents that are resistant to high temperatures and abrasion.

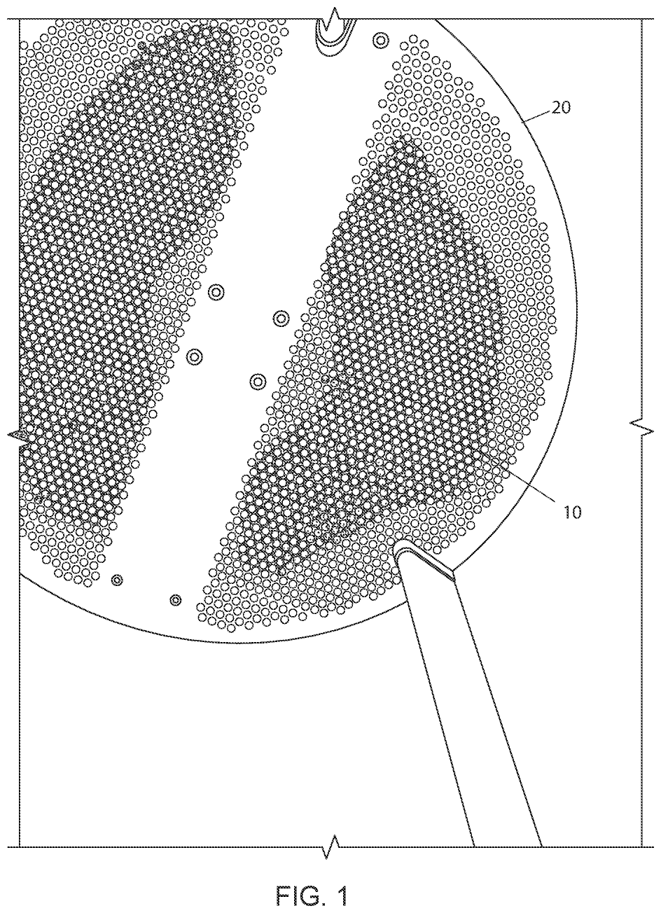

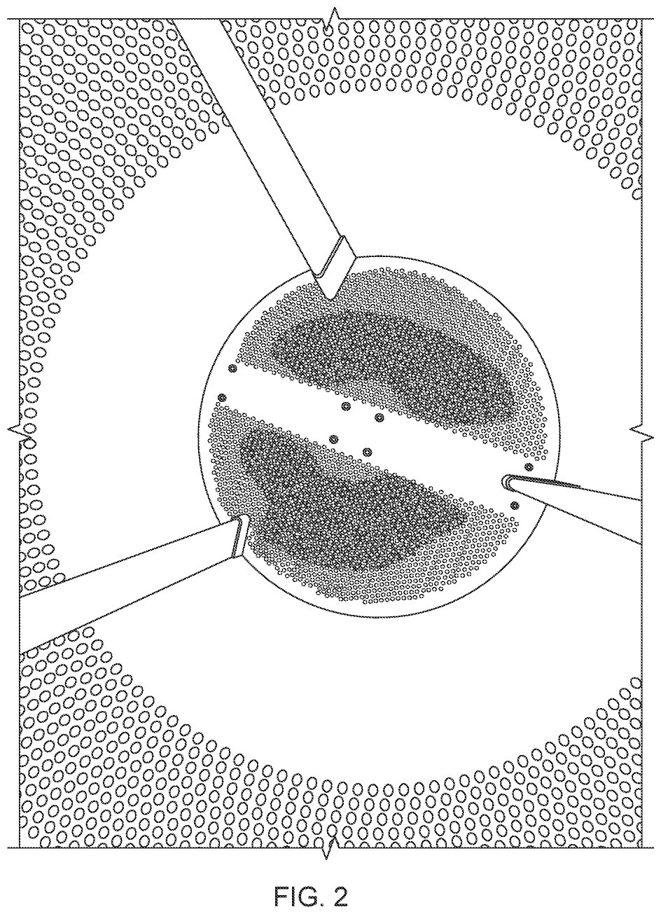

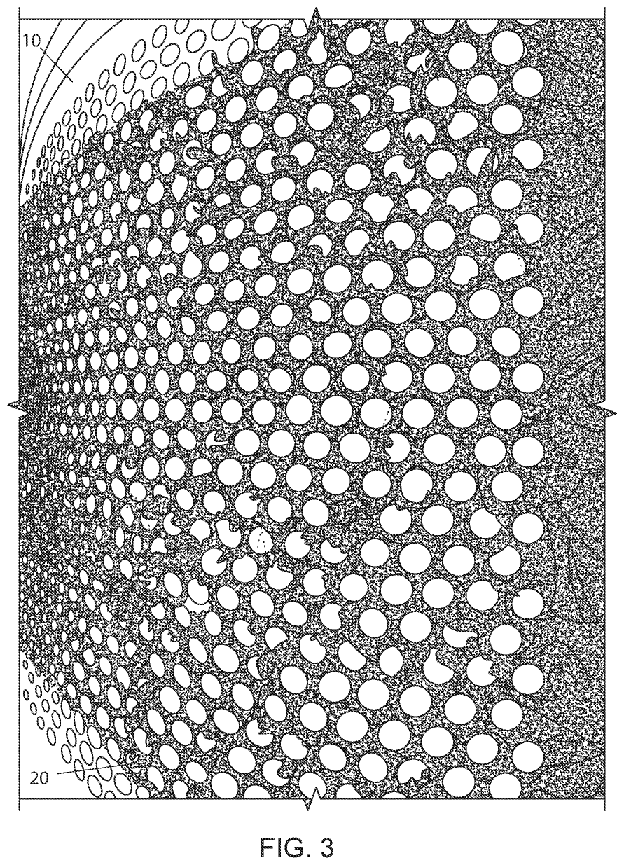

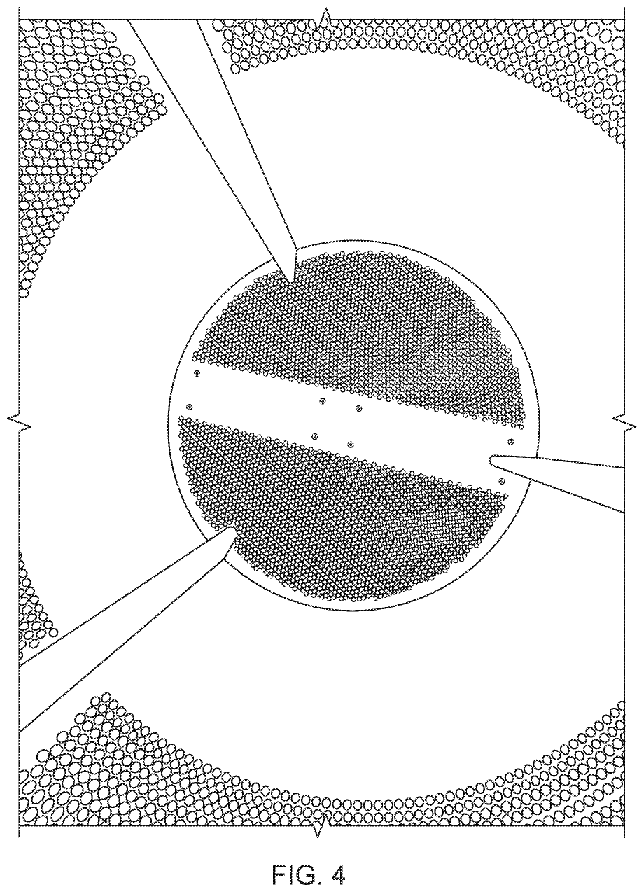

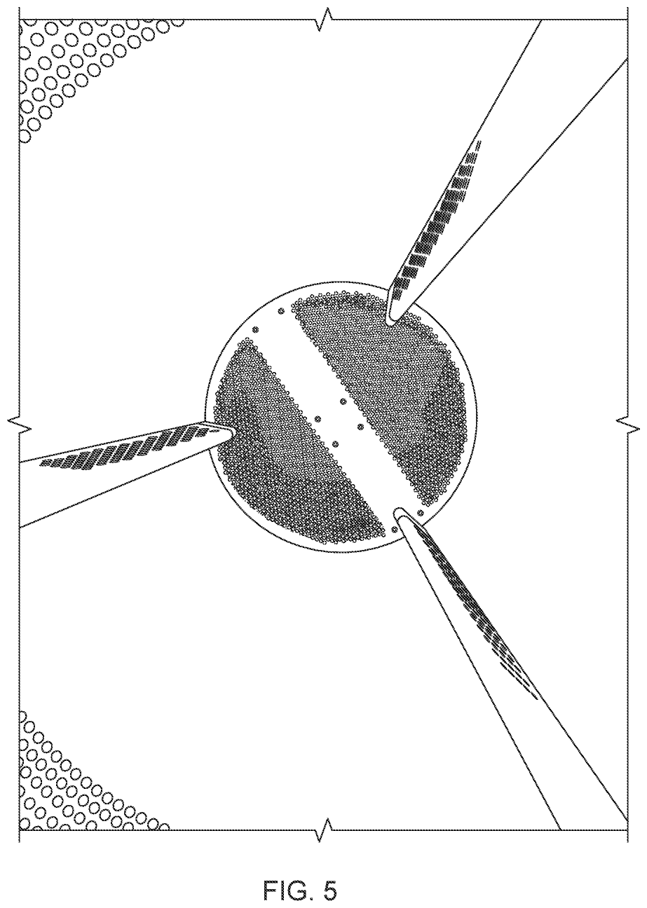

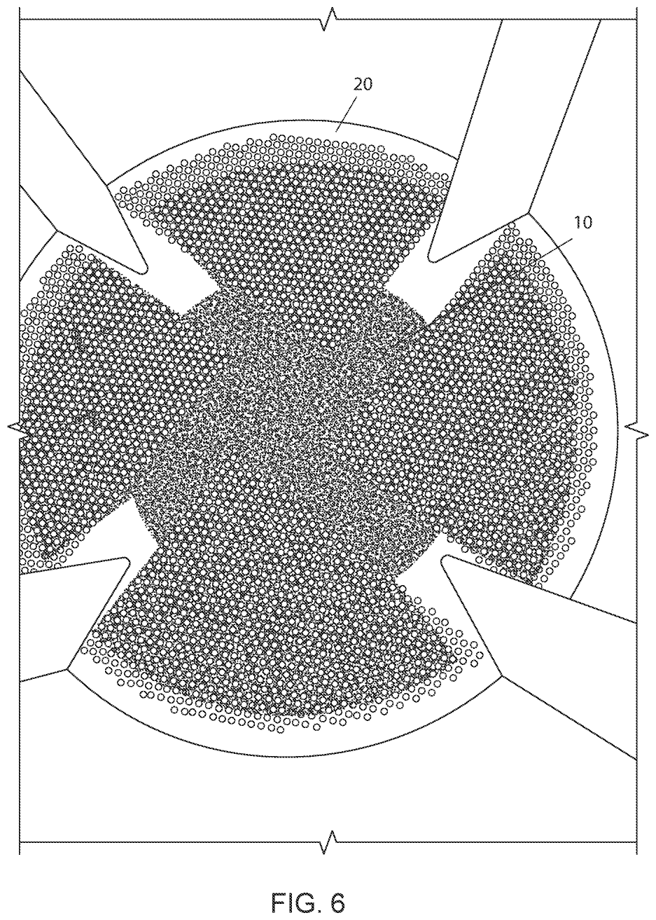

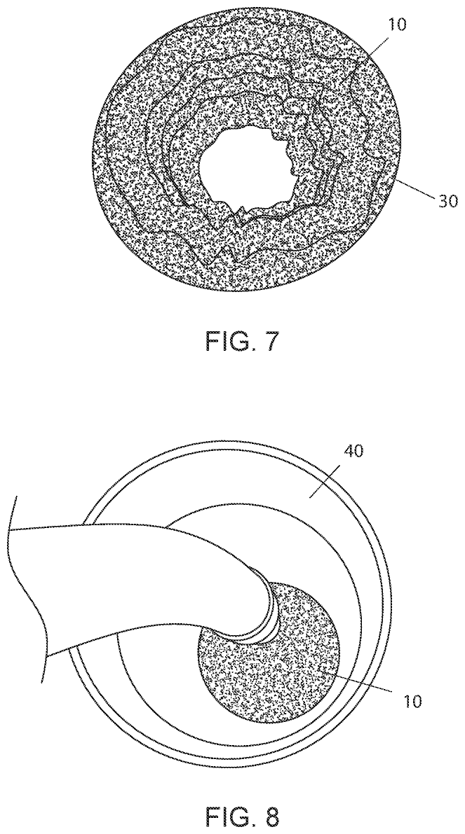

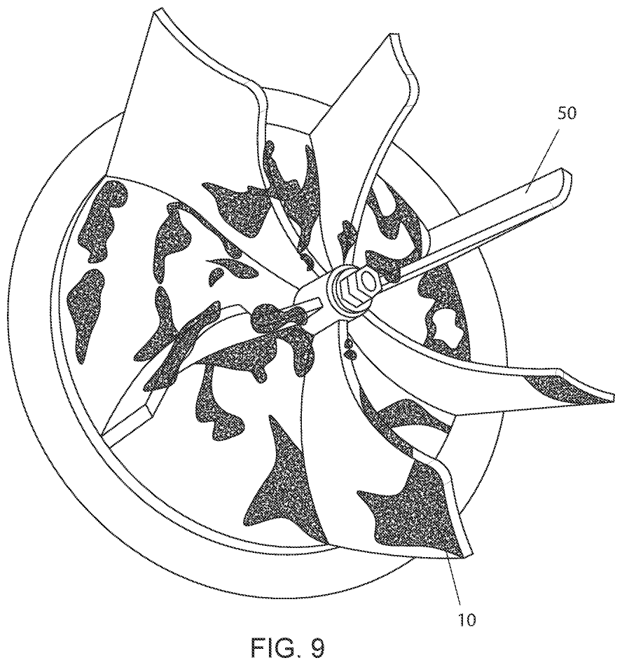

Referring to FIGS. 1-9, the present invention may include a method for protecting dryer components by coating the relevant surfaces with a coating that contains silver or silver oxide. When heated or wet, the coating produces ions that kills bacteria, microbes, virus, and others. The anti-microbial coating may be applied to the dryer components and duct. The present invention may be applied as a coating to dryer components such as vent, fans and airways but not limited to above.

Silver Oxide is formed on the surface of the coating embodied in the present invention, which simultaneously attacks multiple sites within the pathogenic cell to deactivate critical physiological and reproductive functions of the cell. Silver ions have a high affinity for negatively charged side groups on bacterial molecules, which bind to the bacterial DNA. This hinders bacterial replication and simultaneously deactivates the metabolic enzymes of the cell, stopping or killing the reproduction of the microorganism. A key advantage of anti-microbial silver is its remarkably low human toxicity combined with a broad spectrum of antibacterial efficacy.

The addition of nano-sized glass particles (nanoparticles) containing selected metals that produce anti-microbial silver oxide ions, in the presence of moisture, may be formulated into a specified coating. These particles may be dispersed at the surface and also throughout the coating.

Additionally, a higher concentration of anti-microbial particles can be created at and along the surface. Glass, as the matrix material, has high chemical inertness. More importantly, glass can retain metal ions, which are continually liberated in the presence of moisture.

The present invention contemplates use of inorganic materials because they have superior features of safety (non-volatility) and heat resistance to 500° C. The glass, inorganic matrix provides long-term properties. As per Orion Industries Ltd., these anti-microbial materials have been tested safe for the human body. More than 500+ liquid and powder coatings can be modified to have anti-microbial properties.

Anti-microbial properties on the surface of the coating embodied in the present invention may be permanent and remain effective even after the coating is cleaned.

The development of microbe resistance due to generational mutations to anti-microbial silver would be extremely rare because an organism would have to undergo simultaneous mutations in every critical function, within a single generation, to escape the silver's influence.

The present invention has been laboratory tested with pathogen kill rates of 99.9%.

The thickness of coating, including the anti-microbial materials, may be result in an approximately 0.0005″ to 0.002″ coating thickness that is added to the surface.

Dryer components may be coated with polytetrafluoroethylene, ethylene tetrafluoroethylene, Xylan, or another non-stick coating that would resist the high temperature and abrasion and overall improve their durability. The coating may provide a non-stick surface to which the fibers would not adhere and will resist abrasion from tumbling all kind of garments. The nonstick coating may be a Teflon™ or a generic Teflon™.

The nonstick coating may be any of the following and applied to the interior of a dryer. These are given by way of example. The present invention may not be limited to those specifically identified.
MolyDag® 254
Emralon® 330
Emralon® 334
Emralon® 306
MolyDag® 261
Emralon® 333
Emralon® 305
GP1904
Daikin Polyflon PTFE Coating
FluoroBond® R
FluoroPlate®
FluoroPlate® AM
FluoroWire®
FluoroGlass®
FluoroMed®
FluoroSteel®
Xylan®
Quantanium®
Ultralon®
Eclipse®
Teflon®
Teflon® 958
Teflon® 456
Teflon® 459
Teflon® 850
Teflon® 852
Teflon® 856
Teflon® 959
Krytox®
Teflon® S
Teflon® 420
Teflon® 954
Teflon® 532
Teflon® 851
Teflon® 855
Teflon® 857
Carlon®
IFALON Resist
Durit®
IFALON Resist Plus

The non-stick coating may be applied to the dryer components, including but not limited to ducts, vents, airways fans and other ventilation, air condition or heating systems and their subcomponents. The non-stick coating and the anti-microbial nanoparticles may be combined as the non-stick, low-friction coating properties unaffected by the anti-microbial nanoparticles. Wide range of non-stick and low friction coatings can be formulated with the anti-microbial properties of the present invention.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

also, it is understood the terms such as “components” means drum, cylinder, basket, vent, duct, airways, fan, blower, bulkhead of the dryer.

1-11. (canceled)

12. A method of preventing the buildup of melted synthetic fibers and lint and for hindering bacterial replication along a dryer component, the method comprising:
combining a non-stick coating and anti-microbial nanoparticles; and
applying the combination of the non-stick coating and the anti-microbial nanoparticles along the surface of the dryer component.

13. The method of claim 12, wherein the anti-microbial nanoparticles are configured to not affect low-friction properties of the non-stick coating.

14. A method of preventing the buildup of melted synthetic fibers and lint and for hindering bacterial replication along a dryer component, the method comprising:
combining a non-stick coating and an anti-microbial coating; and
applying the combination of the non-stick coating and the anti-microbial coating along the surface of the dryer component.

15. The method of claim 14, wherein the non-stick coating comprises formation of silver ions.

16. The method of claim 15, wherein the formation of silver ion is embodied in silver oxide along said surface.

17. The method of claim 15, wherein the formation of silver ion is embodied in the anti-microbial coating along said surface.

18. The method of claim 15, wherein the anti-microbial coating embodies matrix material nanoparticles containing metals that produce the silver ions.

19. The method of claim 18, wherein the matrix material nanoparticles is glass.

20. The method of claim 18, wherein the matrix material nanoparticles is an inorganic material.

21. The method of claim 18, wherein the anti-microbial coating, including the matrix material materials has a thickness between 0.0005 to 0.002 inches.

22. The method of claim 14, wherein the non-stick coating is resistant to high temperature and abrasion from tumbling articles of clothing comprised on synthetic fibers.

23. The method of claim 14, wherein the non-stick coating provides a non-stick surface to which synthetic fibers and lint do not adhere.

24. The method of claim 14, wherein the non-stick coating comprises at least one of the following: polytetrafluoroethylene, ethylene tetrafluoroethylene, Xylan, MolyDag® 254, Emralon® 330, Emralon® 334, Emralon® 306, MolyDag® 261, Emralon® 333, Emralon® 305, GP1904, Daikin Polyflon PTFE Coating, Xylan®, Quantanium®, Ultralon®, Eclipse®, Teflon®, Teflon® 958, Teflon® 456, Teflon® 459, Teflon® 850, Teflon® 852, Teflon® 856, Teflon® 959, Krytox®, Teflon® S, Teflon® 420, Teflon® 954, Teflon® 532, Teflon® 851, Teflon® 855, Teflon® 857, Conlon®, IFALON Resist, Durit®, or IFALON Resist PIus™, FluoroPlatee, FluoroPlate® AM.
